(19) United States
(12) Patent Application Publication
(10) Pub. No.: US 2013/0122369 A1
(43) Pub. Date: May 16, 2013

(54) NEGATIVE ACTIVE MATERIAL FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Bong-Chull Kim, Yongin-si (KR); Kang-Kook Jung, Yongin-si (KR); Hyung-Dong Lee, Yongin-si (KR); Na-Rae Park, Yongin-si (KR); Jae-Hoon Kim, Yongin-si (KR); Hyun-Jun Choi, Yongin-si (KR); Sung-Soo Park, Yongin-si (KR); Sang-Hun Lee, Yongin-si (KR)

(73) Assignee: SAMSUNG SDI CO., LTD., Yongin-si (KR)

(21) Appl. No.: 13/672,245

(22) Filed: Nov. 8, 2012

(30) Foreign Application Priority Data
Nov. 11, 2011 (KR) 10-2011-0117807

(51) Int. Cl. H01M 4/38; H01M 4/04; H01M 4/26; H01M 4/587

(52) U.S. Cl. CPC H01M 4/38; H01M 4/587; H01M 4/0402; H01M 4/26
USPC 429/219; 429/231.8; 429/225; 429/231.6; 429/231.9; 429/220; 429/221; 429/231.5; 241/23; 29/623.5; 977/773; 977/892; 977/948

(57) ABSTRACT

A negative active material for a rechargeable lithium battery and a rechargeable lithium battery including the same. The negative active material includes a carbon-nanoparticle composite including a crystalline carbon material including pores, and amorphous nanoparticles dispersed either inside the pores, or on the surface of the crystalline carbon material, or both inside the pores and on the surface of the crystalline carbon material. At least one of the amorphous nanoparticles includes a metal oxide layer in a form of a film on the surface, and the amorphous nanoparticles have a full width at half maximum of about 0.35 degree (°) or greater at a crystal plane producing the highest peak as measured by X-ray diffraction analysis.

### CLAIM OF PRIORITY

This application makes reference to, incorporates the same herein, and claims all benefits accruing under 35 U.S.C. §119 from an application earlier filed in the Korean Intellectual Property Office on Nov. 11, 2011 and there duly assigned Serial No. 10-2011-0117807.

### BACKGROUND OF THE INVENTION

1. Field of the Invention

This disclosure relates to a negative active material for a rechargeable lithium battery and a rechargeable lithium battery including the same.

2. Description of the Related Art

Lithium rechargeable batteries have recently drawn attention as a power source of small portable electronic devices. The lithium rechargeable batteries use an organic electrolyte solution and thereby have twice or more the discharge voltage than that of a conventional battery using an alkali aqueous solution, and accordingly have high energy densities.

As positive active materials of a rechargeable lithium battery, lithium-transition element composite oxides being capable of intercalating lithium such as LiCoO₂, LiMn₂O₄, LiNi₁₋ₓCoₓO₂ (0<x<1), and the like have been researched.

As negative active materials of a rechargeable lithium battery, various carbon-based materials such as artificial graphite, natural graphite, and hard carbon, which can all intercalate and deintercalate lithium ions, have been used. Recently research has been conducted regarding non-carbon-based negative active materials such as Si, however, due to the need for stability and high-capacity.

### SUMMARY OF THE INVENTION

One embodiment of the present invention provides an improved negative active material for a rechargeable lithium battery.

Another embodiment provides a negative active material for a rechargeable lithium battery having improved cycle-life characteristics.

Another embodiment provides a rechargeable lithium battery including the negative active material.

According to one embodiment, a negative active material for a rechargeable lithium battery is constructed with a carbon-nanoparticle composite which includes a crystalline carbon material including pores, and amorphous nanoparticles dispersed either inside the pores, or on the surface of the crystalline carbon material, or both inside the pores and on the surface of the crystalline carbon material. At least one of the amorphous nanoparticles includes a metal oxide layer in a form of a film on the surface of the amorphous nanoparticles. The amorphous nanoparticles have a full width at half maximum of about 0.35 degree (°) or greater at a crystal plane producing the highest peak as measured by X-ray diffraction analysis.

The crystalline carbon material may include natural graphite, artificial graphite, or a mixture thereof.

The crystalline carbon material may have a porosity of about 15% to about 50%.

The amorphous nanoparticles may include one selected from a group consisting of silicon (Si), a silicon-containing alloy (Si—X) (wherein X is an element selected from an alkali metal, an alkaline-earth metal, a group 13 element, a group 14 element, a group 15 element, a group 16 element, a transition element, a rare earth element, and a combination thereof, and not Si), tin (Sn), a tin-containing alloy (Sn—X′) (wherein X is an element selected from an alkali metal, an alkaline-earth metal, a group 13 element, a group 14 element, a group 15 element, a group 16 element, a transition element, a rare earth element, and a combination thereof, and not Sn), lead (Pb), indium (In), arsenic (As), antimony (Sb), silver (Ag), and a combination thereof. The X and X′ may be selected from magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), technetium (Tc), rhenium (Re), iron (Fe), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), indium (In), germanium (Ge), phosphorus (P), arsenic (As), antimony (Sb), bismuth (Bi), sulfur (S), selenium (Se), tellurium (Te), and a combination thereof.

The amorphous nanoparticles may have an average particle diameter of about 50 nm to about 200 nm, and in one embodiment about 60 nm to about 180 nm, in terms of manufacture processes and cycle-life improvement.

The metal oxide layer is formed at a thickness of about 1 nm to about 20 nm.

The metal oxide layer may include a metal oxide selected from the group consisting of titanium (Ti), copper (Cu), iron (Fe), molybdenum (Mo), aluminum (Al), and a combination thereof. The metal oxide of metal oxide layer may be included in about 1 to about 5 parts by weight based on 100 parts by weight of the amorphous nanoparticles.

The amorphous nanoparticles may be included in about 5 to about 25 parts by weight based on 100 parts by weight of the crystalline carbon material.

The negative active material according to another embodiment may further include an amorphous carbon surrounding the carbon nanoparticle composite.

The amorphous carbon may be present in at least one pore of carbon nanoparticle composite or between the surface of crystalline carbon material and the amorphous nanoparticles.

The amorphous carbon may include a material selected from a group consisting of soft carbon, hard carbon, mesophase pitch carbide, baked coke, or a mixture thereof.

The amorphous carbon may be included in, for example, about 5 to about 25 parts by weight based on 100 parts by weight of the crystalline carbon material.

According to another embodiment of the present invention, a method of manufacturing a negative active material is provided that includes milling particles by using beads having an average particle diameter of about 50 μm to about 300 μm for about 24 hours or longer to provide amorphous nanoparticles, mixing the amorphous nanoparticles with a composition including a metal oxide precursor and heating the same to provide amorphous nanoparticles formed with a metal oxide layer on the surface thereof, and mixing and combining the amorphous nanoparticles formed with the metal oxide layer on the surface thereof with a crystalline carbon material including pores.

According to further another embodiment of the present invention, a method of manufacturing a negative active material is provided that includes milling conductive particles by using beads having an average particle diameter of about 50 μm to about 300 μm for greater than or equal to 24 hours to provide amorphous conductive nanoparticles, mixing the amorphous nanoparticles with a composition including a metal oxide precursor to prepare amorphous nanoparticles formed with the metal oxide layer on the surface thereof, and mixing the amorphous nanoparticles formed with the metal oxide layer on the surface thereof with a crystalline carbon material including pores and heating the same to be combined.

The beads may include metal oxide beads, metal nitride beads, metal carbide beads, or a combination thereof, or may include zirconia beads, alumina beads, silicon nitride beads, silicon carbide beads, silica beads, or a combination thereof.

The metal oxide precursor may be a salt or an alkoxide including a metal selected from the group consisting of titanium (Ti), copper (Cu), iron (Fe), molybdenum (Mo), aluminum (Al), and a combination thereof.

The heating process after mixing the amorphous nanoparticles and a composition including a metal oxide precursor or the heating process after mixing the amorphous nanoparticles formed with a metal oxide layer on the surface thereof with a crystalline carbon material including pores may be performed at about 400° to about 600°.

According to yet further another embodiment, a rechargeable lithium battery is provided that includes a negative electrode including the negative active material, a positive electrode including a positive active material, and a non-aqueous electrolyte.

The negative electrode may include a mixture including the negative active material and another crystalline carbon material.

Further embodiments are described in the detailed description.

The negative active material for a rechargeable lithium battery improves cycle-life.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic view illustrating a negative active material constructed as one embodiment according to the principles of the present invention;

FIG. 2 is a schematic view illustrating a negative active material constructed as another embodiment according to the principles of the present invention;

FIG. 3 is a schematic view illustrating a structure of a rechargeable lithium battery constructed as one embodiment according to the principles of the present invention;

FIG. 4 is a transmission electron microscope (TEM) photograph of Si nano particles coated with TiO₂₋ₓ (0≦x≦1) according to Example 1;

FIG. 5 is a view illustrating EDX analysis results of Si nano particles coated with TiO₂₋ₓ (0≦x≦1) according to Example 1; and

FIG. 6 is a flow chart illustrating a method of manufacturing a negative active material as an embodiment according to the principles of the present invention.

### DETAILED DESCRIPTION OF THE INVENTION

Exemplary embodiments will hereinafter be described in detail. However, these embodiments are exemplary, and this disclosure is not limited thereto.

The negative active material constructed as one embodiment according to the principles of the present invention includes a composite of a crystalline carbon material including pores and nano particles. The nano particles includes amorphous conductive nanoparticles dispersed either inside the pores of the crystalline carbon material, or on the surface of the crystalline carbon material, or both inside the pores and on the surface of the crystalline carbon material. The surface of each nanoparticle is coated with a metal oxide layer in the form of a film.

The crystalline carbon material indicates an agglomerate of at least two carbon particles.

As used herein, the amorphous nanoparticles may include any conductive or semiconductor material being capable of producing an alloy with Li electrochemically. In one embodiment, the conductive or semiconductor material has different potentials when reacting with Li ions electrochemically depending on the kind of material, and electrochemically reacts with Li ions at a low potential.

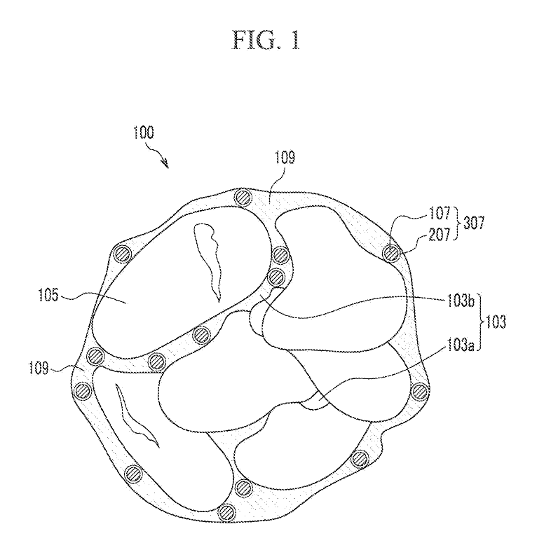

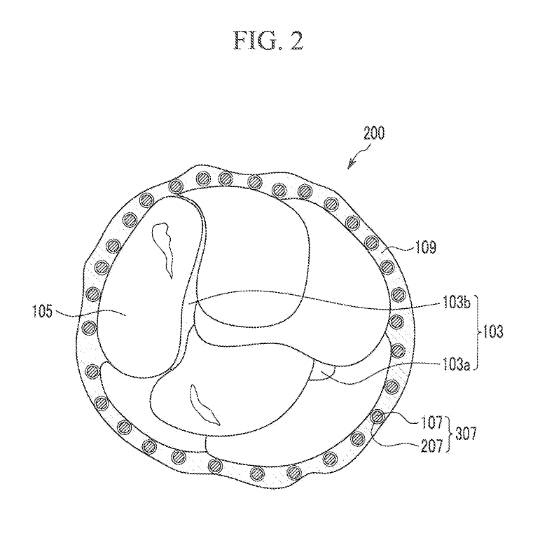

The structure of the negative active material is schematically illustrated in FIGS. 1 and 2, but the structure of the negative active material according to one embodiment is not limited thereto.

FIG. 1 is a schematic view illustrating a negative active material constructed as one embodiment according to the principles of the present invention. Referring to FIG. 1, the negative active material 100 constructed as one embodiment according to the principles of the present invention includes a carbon-nanoparticle composite including a crystalline carbon material 105 including pores 103, and amorphous nanoparticles 107 dispersed both inside the pores 103 and on the surface of the crystalline carbon material 105. The amorphous nanoparticles 107 include a metal oxide layer 207 in a form of a film on the surface of the amorphous nanoparticles 107, and have a full width at half maximum of about 0.35 degree (°) or greater at a crystal plane showing the highest peak as measured by X-ray diffraction analysis. In one embodiment, the crystal plane maybe (111) plane.

FIG. 2 is a schematic view illustrating a negative active material constructed as another embodiment according to the principles of the present invention. FIG. 2 is a schematic view illustrating a negative active material 200 including the amorphous nanoparticles 107 disposed on the surface of the crystalline carbon material 105 and not inside the pores 103 of the crystalline carbon material 105.

The crystalline carbon material 105 including the pores 103 buffers volume expansion of the amorphous nanoparticles 107 during charge and discharge, and improves electrical conductivity of the negative active materials 100 and 200.

The crystalline carbon material 105 may be natural graphite, artificial graphite, or a mixture thereof being capable of reversibly intercalating and deintercalating lithium ions.

When the crystalline carbon material 105 is graphite, the crystalline carbon 105 is generally manufactured in a spherical shape by agglomerating flake-shaped graphite fine powders or massive graphite fine powders. The graphite fine powders are agglomerated by dropping graphite fine powders from a predetermined height in an agglomerating apparatus, colliding edges of the fine powders with walls of the apparatus, and bending the edges. After agglomerating the graphite fine powders, the crystalline carbon material 105 has a particle diameter of about 1 micrometer to about 15 micrometer.

The fine powders of the crystalline carbon material 105 have a particle size of about 1 μm to about 5 μm. When the particle size is less than about 1 μm, a sufficient expansion buffering effect is not obtained since the porosity of the crystalline carbon material 105 is less than about 15%, while when the particle size is more than about 5 μm, sufficient strength of the crystalline carbon material 105 is not obtained since the porosity of the crystalline carbon material 105 is more than about 50%.

The crystalline carbon material 105 may be formed in a conical or cylindrical shape in addition to a complete spherical shape.

Alternative methods for agglomerating flake-shaped graphite as the crystalline carbon material 105 include the processes of providing the flake-shaped graphite fine powders in air flow, colliding the graphite fine powders with a wall surface of a crusher, and folding and bending edges of the flake-shaped graphite.

During the agglomeration process of the fine powders of the crystalline carbon material 105, pores 103 may be formed inside the crystalline carbon material 105. Further, such pores 103 may be formed using a blow agent. The pores 103 include closed pores 103a and open pores 103b inside the crystalline carbon material 105. The pores 103 may provide a three-dimensional network. The pores 103 inside the crystalline carbon material 105 may promote buffering effects during the charge/discharge when amorphous nanoparticles 107 such as Si nanoparticles undergo volume expansion.

The crystalline carbon material 105 including the pores 103 may have a porosity ranging from about 15% to about 50% based on the total volume of the crystalline carbon material. When the crystalline carbon material 105 has the porosity within the range, the negative active material may accomplish buffering effects of volume expansion as well as sufficiently maintain mechanical strength.

The negative active material may include the amorphous nanoparticles 107 dispersed inside the pores 103 or on the surface of the crystalline carbon material 105.

The amorphous nanoparticles 107 has a full width at half maximum of about 0.35 degree (°) or greater at a crystal plane showing the highest peak as measured by X-ray diffraction analysis using CuKα, which indicates that the nanoparticles 107 are amorphous. The amorphous nanoparticles 107 may have no peak at the crystal plane showing the highest peak. For example, Si nanoparticles shows the highest peak at a (111) plane and have a full width at half maximum of about 0.35 degree (°) or greater at a (111) plane. When the amorphous nanoparticles have a full width at half maximum of less than about 0.35 degree (°), they may not improve cycle-life of a battery.

The amorphous nanoparticles 107 have an average particle diameter ranging from about 50 nm to about 200 nm, and in one embodiment, from about 60 nm to about 180 nm. When the amorphous nanoparticles 107 have an average particle diameter within the range, the amorphous nanoparticles 107 may suppress volume expansion generated during the charge and discharge and prevent a conductive path from being blocked by particles that are broken during the charge and discharge.

In general, particles having diameters of several micrometers may have a conductive path that is cut by broken particles when a battery is repeatedly charged and discharged, resultantly bringing about severe capacity deterioration. However, when particles are made into nanoparticles and are simultaneously amorphous according to one embodiment, they may prevent the conductive path cut during the charge and discharge, improving cycle-life characteristic of a battery.

The amorphous nanoparticles 107 may include one selected from a group consisting of silicon (Si), a silicon-containing alloy (Si—X) (wherein X is an element selected from a group consisting of an alkali metal, an alkaline-earth metal, a group 13 element, a group 14 element, a group 15 element, a group 16 element, a transition element, a rare earth element, and a combination thereof, and is not Si), tin (Sn), a tin-containing alloy (Sn—X′) (wherein X′ is an element selected from a group consisting of an alkali metal, an alkaline-earth metal, a group 13 element, a group 14 element, a group 15 element, a group 16 element, a transition element, a rare earth element, and a combination thereof, and is not Sn), lead (Pb), indium (In), arsenic (As), antimony (Sb), silver (Ag), and a combination thereof. The X and X′ may be selected from magnesium (Mg), calcium (Ca), strontium (Sr), barium (Ba), scandium (Sc), yttrium (Y), titanium (Ti), zirconium (Zr), hafnium (Hf), vanadium (V), niobium(Nb), tantalum (Ta), chromium (Cr), molybdenum (Mo), tungsten (W), technetium (Tc), rhenium (Re), iron (Fe), ruthenium (Ru), osmium (Os), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), indium (In), germanium (Ge), phosphorus (P), arsenic (As), antimony (Sb), bismuth (Bi), sulfur (S), selenium (Se), tellurium (Te), and a combination thereof.

The surface of amorphous nanoparticles 107 is formed with a metal oxide layer 207. In addition, the metal oxide layer 207 is not coated in a discontinuous form, but is formed as a coating layer of continuous thin film.

The metal oxide layer 207 may be formed in a thickness of about 1 nm to about 20 nm. When the metal oxide layer 207 is formed in a thickness within the range, the battery early efficiency, the capacity, and the cycle-life characteristics may be improved.

The metal oxide layer 207 may include an oxide of metal selected from the group consisting of titanium (Ti), copper (Cu), iron (Fe), molybdenum (Mo), aluminum (Al), and a combination thereof. These oxides are reacted with lithium ion during the charge and discharge to provide a lithium-included compound, which is participated in the charge and discharge, so the battery efficiency may be improved. In addition, the oxide including aluminum may improve the battery safety.

These metal oxide layer 207 may include a metal oxide that stoichiometrically lacks oxygen.

The metal oxide of metal oxide layer 207 may be included in about 1 to about 5 parts by weight based on 100 parts by weight of amorphous nanoparticles. Within the range, the battery early efficiency, the capacity, and the cycle-life may be improved.

According to one embodiment, the amorphous nanoparticles 107 may be included in an amount of about 5 to about 25 parts by weight based on 100 parts by weight of the crystalline carbon material 105, and in another embodiment, the amorphous nanoparticles 107 may be included in an amount of about 5 to 15 parts by weight based on 100 parts by weight of the crystalline carbon material 105. When the amorphous nanoparticles 107 are included within the range, the amorphous nanoparticles 107 may increase the capacity per weight characteristic to about 1.5 to about 3 times that of crystalline carbon by weight.

The negative active material 100 may further include amorphous carbon 109 surrounding at least one surface of a composite of the amorphous nanoparticles 107 and crystalline carbon material 105. The amorphous carbon 109 may fill the space inside the pores 103 where the amorphous nanoparticles 107 are disposed.

The amorphous carbon 109 may include soft carbon, hard carbon, meso-phase pitch carbide, baked coke, or a mixture thereof.

The amorphous carbon 109 included in a negative active material 100 according to one embodiment may be formed between the amorphous nanoparticles 307 including the metal oxide layer 207 on the surface thereof to separate the amorphous nanoparticles 307 from each other. In addition, the amorphous carbon 109 may be formed between the plurality of amorphous nanoparticles 307 and the crystalline carbon material 105 so that the amorphous nanoparticles 307 may be spaced a part from the surface of the pore 103 of the crystalline carbon material 105. The amorphous nanoparticles 307 includes a metal oxide layer 207 formed on the surface of the amorphous nanoparticles 107. In other words, the amorphous carbon 109 may substantially surround a plurality of amorphous nanoparticles 307 including the metal oxide layer 207 formed on the surface thereof, so that a plurality of amorphous nanoparticles 307 may not directly contact the pore surface of the pores 103 of the crystalline carbon material 105. The term “substantially surround” means that a majority of amorphous nanoparticles 307 with the metal oxide layer 207 formed on the surface thereof is surrounded by the amorphous carbon 109 so that the majority of the amorphous nanoparticles 307 do not contact the walls of the pore 103. Accordingly, the amorphous nanoparticles 307 may have suppressed volume expansion despite repeated charge and discharge.

The amorphous nanoparticles 307 including the metal oxide layer 207 formed on the surface thereof may be further disposed on the external surface of the crystalline carbon material 105. The amorphous carbon 109 may be disposed on the amorphous nanoparticles 307 and crystalline carbon material 105, and for example the amorphous carbon 109 may cover the amorphous nanoparticles 307 with the metal oxide layer 207 formed on the surface thereof and the crystalline carbon material 105.

The amorphous carbon 109 may be included in an amount ranging from about 5 to about 25 parts by weight based on 100 parts by weight of the crystalline carbon material 105. When the amorphous carbon 109 is included within the range, a plurality of amorphous nanoparticles 307 with the metal oxide layer 207 formed on the surface thereof may be disposed to be sufficiently apart from the internal surface of the pores 103.

The negative active materials 100 and 200 may have an average particle diameter ranging from about 5 μm to about 40 μm. This negative active material may be mixed with another crystalline carbon material. Such a crystalline carbon material may include natural graphite, artificial graphite, or a combination thereof. When the crystalline carbon material included in the negative active materials 100 and 200 is natural graphite, the another crystalline carbon may be artificial graphite.

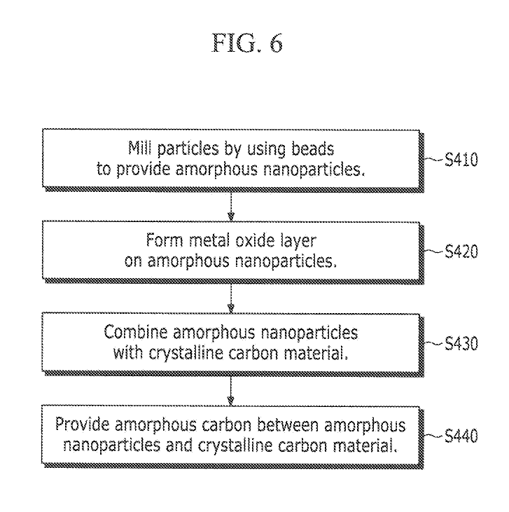

The negative active material according to one embodiment is prepared in the following process as an embodiment according to the principles of the present invention. FIG. 6 is a flow chart illustrating a method of manufacturing a negative active material as an embodiment according to the principles of the present invention.

First of all, amorphous nanoparticles are prepared by milling particles for about 24 hours or longer by using beads with an average particle diameter ranging from about 50 μm to about 300 μm, and specifically about 50 μm to about 150 μm (step 410).

The beads may include metal oxide beads, metal nitride beads, or metal carbide beads, and in particular, zirconia beads, alumina beads, silicon nitride beads, silicon carbide beads, silica beads, and the like may be used, but they are not limited thereto. The beads may have Vickers hardness (load: 500 g) ranging from about 8 GPa to about 25 GPa, and in one embodiment, from about 10 GPa to 23 GPa. The milling process may be performed for about 24 to about 400 hours. The amorphous nanoparticles milled by the beads may have an average particle diameter ranging from about 50 nm to about 200 nm, and in one embodiment, from about 60 nm to about 180 nm, and may be sufficiently amorphous to have a full width a half maximum of 0.35 degree (°) or more at a crystal plane showing the highest peak as measured by X-ray diffraction analysis using CuKα.

In order to coat the surface of amorphous nanoparticles with a metal oxide, the metal oxide precursor is dissolved in a solvent to provide a composition including the metal oxide precursor. The metal oxide precursor may include a salt or an alkoxide including a metal selected from the group consisting of titanium (Ti), copper (Cu), iron (Fe), molybdenum (Mo), aluminum (Al), and a combination thereof. The metal oxide precursor may be added in a solvent or a dispersion medium capable of dissolving or dispersing the same. The solvent or dispersion medium may include alcohol or pure water, but is not limited thereto.

The composition including the metal oxide precursor may be coated on the surface of amorphous nanoparticles by using a wet coating method such as dipping, spray coating or the like. Then amorphous nanoparticles are dried to remove the solvent, and then amorphous nanoparticles are heated at about 400° C. to about 600° C. to provide a metal oxide layer on the surface of amorphous nanoparticles (step 420).

The heat treatment process may be performed under the reduction atmosphere. The reduction atmosphere may include hydrogen or a mixed gas of hydrogen and nitrogen. In this case, the metal oxide that stoichiometrically lacks oxygen may be provided.

The amorphous nanoparticles formed with a metal oxide layer on the surface thereof and the crystalline carbon material is mixed in a solvent. The solvent may include a non-aqueous solvent, for example, alcohol, toluene, benzene, or a combination thereof.

The amorphous nanoparticles formed with a metal oxide layer on the surface thereof may be dispersed in the pore of the crystalline carbon material by using a capillary phenomenon (step 430). In addition, the amorphous nanoparticles may be present on the surface of crystalline carbon material while not entering the pores of the crystalline carbon material. Then, a precursor of amorphous carbon is added to the obtained product in a solvent, and the mixture is heated. Examples of the amorphous carbon precursor may include coal pitch, mesophase pitch, petroleum pitch, coal-based oil, petroleum-based heavy oil, or a polymer resin such as a phenol resin, a furan resin, a polyimide resin, and the like.

According to the manufacturing method of one embodiment, the mixing ratio of crystalline carbon material, amorphous nanoparticles, and amorphous carbon precursor may be adjusted to provide about 70 wt % to about 90 wt % of the crystalline carbon material, about 5 to about 15 wt % of amorphous nanoparticles, about 5 wt % to about 15 wt % of amorphous carbon based on the entire weight of the negative active material, without specific limitation.

Next, a heat treatment may be performed at about 600° C. to about 1200° C. The amorphous carbon precursor is carbonized by the heating treatment and transferred to amorphous carbon so as to surround both the crystalline carbon material and the amorphous nanoparticles present on the surface of crystalline carbon material to provide a coating layer (step 440).

As another embodiment according to the principles of the present invention, the amorphous nanoparticles may be formed with the metal oxide layer on the surface thereof during the combining process of the amorphous nanoparticles and the crystalline carbon material.

In this embodiment, the amorphous nanoparticles are provided by milling beads having an average particle diameter of about 50 μm to about 300 μm, for example, about 50 μm to about 150 μm for about 24 hours or longer to provide amorphous nanoparticles.

The amorphous nanoparticles are dispersed in and mixed with a composition including a metal oxide precursor and a solvent, and the mixture is heated to remove the solvent and to provide the amorphous nanoparticles formed with the metal oxide layer on the surface thereof. Then, the amorphous nanoparticles formed with the metal oxide layer on the surface thereof are combined with the crystalline carbon material by wet-mixing the amorphous nanoparticles formed with the metal oxide layer and the crystalline carbon material and then heating the same. The heating process after mixing the amorphous nanoparticles formed with the metal oxide on the surface thereof with the crystalline carbon material including pores is performed at about 400° C., to about 600° C.

The beads and the composition including the metal oxide precursor is the same as described in above. The composition including the metal oxide precursor is converted into a metal oxide by the heating treatment, and the metal oxide may be independently present in the pores of crystalline carbon material as well as on the surface of amorphous nanoparticles.

The negative active material prepared according to an embodiment may be usefully adopted by a rechargeable lithium battery.

According to another embodiment, a rechargeable lithium battery includes a negative electrode including a negative active material, a positive electrode including a positive active material, and a non-aqueous electrolyte.

The negative electrode includes a current collector and a negative active material layer formed on the current collector. The negative active material layer includes the negative active material. The negative active material layer may include about 95 wt % to about 99 wt % of the negative active material based on total weight of the negative active material layer.

The negative active material layer may include a binder, and selectively a conductive material. The negative active material layer may include about 1 wt % to about 5 wt % of a binder based on the total weight of the negative active material layer. In addition, when the negative active material layer further includes a conductive material, it may include about 90 wt % to about 98 wt % of the negative active material, about 1 wt % to about 5 wt % of the binder, and about 1 wt % to about 5 wt % of the conductive material.

The binder improves binding properties of active material particles with one another and with a current collector. The binder may include a non-water-soluble binder, a water-soluble binder, or a combination thereof.

Examples of the non-water-soluble binder include polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, and combinations thereof.

The water-soluble binder includes a styrene-butadiene rubber, an acrylated styrene-butadiene rubber, polyvinyl alcohol, sodium polyacrylate, a copolymer including propylene and a C2 to C8 olefin, a copolymer of (meth)acrylic acid and (meth)acrylic acid alkyl ester, or a combination thereof.

When the water-soluble binder is used as a negative electrode binder, a cellulose-based compound may be further used to provide viscosity. The cellulose-based compound includes one or more of carboxylmethyl cellulose, hydroxypropylmethyl cellulose, methyl cellulose, or alkaline metal salts thereof. The alkaline metal may be sodium (Na), potassium (K), or lithium (Li). The cellulose-based compound may be included in an amount of 0.1 to 3 parts by weight based on 100 parts by weight of the negative active material.

As for the conductive material, any electro-conductive material that does not cause a chemical change may be used. Non-limiting examples of the conductive material include a carbon-based material such as natural graphite, artificial graphite, carbon black, acetylene black, ketjen black, and carbon fiber; a metal-based material such as a metal powder or a metal fiber including copper, nickel, aluminum, and silver; a conductive polymer such as a polyphenylene derivative; and a mixture thereof.

The negative electrode includes a current collector, and the current collector includes a copper foil, a nickel foil, a stainless steel foil, a titanium foil, a nickel foam, a copper foam, a polymer substrate coated with a conductive metal, or combinations thereof.

The positive electrode includes a current collector and a positive active material layer disposed on the current collector. The positive active material includes lithiated intercalation compounds that reversibly intercalate and deintercalate lithium ions. The positive active material may include a composite oxide including at least one selected from the group consisting of cobalt, manganese, and nickel, as well as lithium. In particular, the following lithium-containing compounds may be used. LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0≦b≦0.5, 0≦c≦0.05); LiₐE_{2-b}X_{b}O_{4-c}D_{c} (0≦b≦0.5, 0≦c≦0.05); LiₐNi_{1-b-c}Co_{b}X_{c}D_{α} (0.90≦a≦1.8, 0≦b≦0.5, 0≦c≦0.05, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α<2); LiₐNi_{1-b-c}Mn_{b}X_{c}O_{2-α}T_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂(PO₄)₃ (0≦f≦2); Li_{(3-f)}Fe₂(PO₄)₃ (0≦f≦2); or LiFePO₄.

In the above formulas, A is selected from the group consisting of Ni, Co, Mn, and a combination thereof; X is selected from the group consisting of Al, Ni, Co, Mn, Cr, Fe, Mg, Sr, V, a rare earth element, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The lithiated intercalation compound may have a coating layer on the surface, or may be mixed with a lithiated intercalation compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for a coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be formed in a method having no adverse influence on properties of a positive active material by including these elements in the compound. For example, the method may include any coating method such as spray coating, dipping, and the like, but is not illustrated in more detail, since it is well-known to those who work in the related field.

The positive active material layer may include about 90 wt % to about 98 wt % based on the total weight of the positive active material layer.

The positive active material layer also includes a binder and a conductive material. The binder and conductive material may be included in amounts of about 1 wt % to about 5 wt % based on the total weight of the positive active material layer, respectively.

The binder improves binding properties of the positive active material particles to one another, and also with a current collector. Examples of the binder include polyvinyl alcohol, carboxylmethyl cellulose, hydroxypropyl cellulose, diacetyl cellulose, polyvinyl chloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material unless it causes a chemical change. Examples of the conductive material include one or more of natural graphite, artificial graphite, carbon black, acetylene black, ketjen black, a carbon fiber, a metal powder or a metal fiber including copper, nickel, aluminum, silver, and the like, or the conductive material may be used along with a polyphenylene derivative.

The current collector may be aluminum (Al) but is not limited thereto.

The negative and positive electrodes may be fabricated by a method including mixing the active material, a conductive material, and a binder in a solvent to provide an active material composition, and coating the composition on a current collector. The electrode manufacturing method is well known, and thus is not described in detail in the present specification. The solvent includes N-methylpyrrolidone and the like, but is not limited thereto. In addition, when a water-soluble binder is used for a negative electrode, water as a solvent may be used to prepare a negative active material composition.

In a non-aqueous electrolyte rechargeable battery of the present invention, a non-aqueous electrolyte may include a non-aqueous organic solvent and a lithium salt.

The non-aqueous organic solvent serves as a medium for transmitting ions taking part in the electrochemical reaction of the battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent may include a mixture of a cyclic carbonate and a linear carbonate. The cyclic carbonate and the linear carbonate are mixed together in a volume ratio of about 1:1 to about 1:9. When the mixture is used as an electrolyte, the electrolyte performance may be enhanced.

In addition, the non-aqueous organic electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 1.

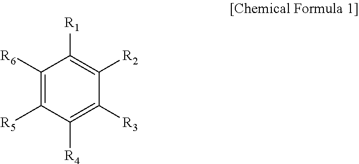

In Chemical Formula 1, R₁ to R₆ are independently selected from the group consisting of hydrogen, a halogen, a C1 to C10 alkyl group, a C1 to C10 haloalkyl group, and a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The non-aqueous electrolyte may further include a solvent of vinylene carbonate, an ethylene carbonate-based compound of the following Chemical Formula 2, or a combination thereof.

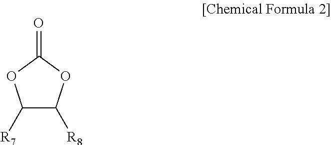

In chemical Formula 2, R₇ and R₈ are the same or different, and are selected from the group consisting of hydrogen, a halogen, a cyano group (CN), a nitro group (NO₂), and a C1 to C5 fluoroalkyl group, provided that at least one of R₇ and R₈ is selected from the group consisting of a halogen, a cyano group (CN), a nitro group (NO₂), and a C1 to C5 fluoroalkyl group.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like.

The solvent may be included in an amount ranging from about 15 volume % to about 30 volume % based on the entire amount of a non-aqueous electrolyte solvent, and can thereby improve the cycle-life characteristic.

The lithium salt supplies lithium ions in the battery, operates a basic operation of a rechargeable lithium battery, and improves lithium ion transport between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiC₂F₅SO₃, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from about 0.1 M to about 2.0 M. When the lithium salt is included at the above concentration range, electrolyte performance and lithium ion mobility may be enhanced due to optimal electrolyte conductivity and viscosity.

The rechargeable lithium battery may further include a separator between the negative electrode and the positive electrode, as needed. Examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

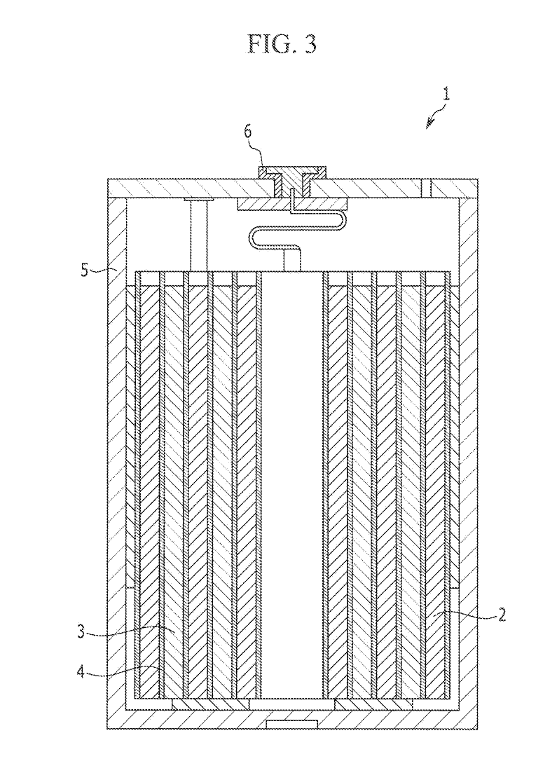

FIG. 3 is a schematic view of a representative structure of a rechargeable lithium battery constructed as one embodiment according to the principles of the present invention. As shown in FIG. 3, the rechargeable lithium battery 1 includes a battery case 5 including a positive electrode 3, a negative electrode 2, and a separator interposed between the positive electrode 3 and the negative electrode 2, an electrolyte solution impregnated therein, and a sealing member 6 sealing the battery case 5.

The following examples illustrate the present invention in more detail. These examples, however, are not in any sense to be interpreted as limiting the scope of this disclosure.

### EXAMPLE 1

Si particles were pulverized by using zirconia beads having a particle diameter of about 100 μm for about 150 hours to provide Si nanoparticles having an average particle diameter (D50) of about 120 nm. The Si nanoparticles were analyzed for X-ray diffraction using CuKα-ray. The result shows that the full width of half maximum was about 0.50 degree (°) at (111) plane.

The X-ray diffraction analysis was performed at a scan speed of about 0.2 degree/min using a X-ray of CuKα wavelength (1.5418 Å) by a X-ray diffraction equipment (model D8 advance) manufactured by Bruker. The X-ray tube had voltage and current of about 40 KV and about 40 mA, respectively. The conditions of divergence slit, anti-scatter slit, and receiving slit were about 0.5 degree (°), about 0.5 degree (°), and about 0.2 mm, respectively.

About 10 g of titanium isopropoxide was dissolved in about 100 g of ethanol to provide a coating composition. The Si nanoparticles were added into the composition and heated at about 400° C. for about 30 hours under the air to provide Si nanoparticles coated with TiO₂₋ₓ(0≦x≦1).

Natural graphite flake minute particles having an average particle diameter of about 3 μm were milled by a rotary mill to provide a spherical natural graphite minute particle having an average particle diameter of about 15 μm. During the milling process, pores including closed pores and open pores were formed inside the spherical natural graphite minute particle while the flake minute particles were agglomerated to each other. By the agglomeration process, the spherical natural graphite minute particle had a porosity of about 15%.

The Si nanoparticle coated with TiO₂₋ₓ (0≦x≦1) was added into ethanol to provide a Si nanoparticle dispersion, and the spherical natural graphite minute particle was dipped into the Si nanoparticle dispersion. The Si nanoparticles and the spherical natural graphite minute particle were present in a weight ratio of about 15:100.

Subsequently, the obtained product and petroleum pitch were mixed and heated at about 900° C. for about 3 hours to provide a negative active material. According to the heating treatment process, the petroleum pitch was carbonized and transferred to amorphous carbon and inserted into closed pores and open pores in the spherical natural graphite minute particle to provide a shell on the surface of spherical natural graphite minute particle.

The amorphous carbon was included in about 10 wt % based on the total amount of negative active material. The negative active material, a styrene-butadiene rubber (SBR) binder, and a carboxylmethyl cellulose (CMC) thickener were mixed in a weight ratio of about 97:2:1 in water to provide a negative active material slurry. The negative active material slurry was coated on a Cu-foil current collector and pressed to provide a negative electrode.

Then LiCoO₂, a polyvinylidene fluoride binder, and carbon black were mixed in a weight ratio of about 96:3:3, to prepare a positive active material slurry. The positive active material slurry was coated on an Al-foil current collector and then compressed to fabricate a positive electrode.

The negative and positive electrodes and a non-aqueous electrolyte were used to fabricate a prismatic battery cell in a common process. The non-aqueous electrolyte was a mixed solvent prepared by dissolving 1.5M of LiPF₆ in ethylene carbonate (EC), fluoroethylene carbonate (FEC), dimethylcarbonate (DMC), and diethylcarbonate (DEC) in a volume ratio of 5:25:35:35.

### EXAMPLE 2

Si particles were pulverized by using zirconia beads having a particle diameter of about 100 μm for about 80 hours to provide Si nanoparticles having an average particle diameter (D50) of about 140 nm. The Si nanoparticle were analyzed for X-ray diffraction analysis according to the same procedure as in Example 1, and the results show that the full width of half maximum was about 0.45 degree (°) at (111) plane. Using the obtained Si nanoparticles, a negative active material was fabricated in accordance with the same procedure as in Example 1, and a prismatic battery cell was fabricated using the same.

### EXAMPLE 3

Si particles were pulverized by using zirconia beads having a particle diameter of about 100 μm for about 60 hours to provide Si nanoparticles having an average particle diameter (D50) of about 160 nm. The Si nanoparticles were analyzed for X-ray diffraction in accordance with the same procedure as in Example 1, and the results show that the full width of half maximum was about 0.40 degree (°) at (111) plane. Using the obtained Si nanoparticles, a negative active material was fabricated in accordance with the same procedure as in Example 1, and a prismatic battery cell was fabricated using the same.

### EXAMPLE 4

Si particles were pulverized by using zirconia beads having a particle diameter of about 100 μm for about 40 hours to provide Si nanoparticles having an average particle diameter (D50) of about 180 nm. The Si nanoparticles were analyzed for X-ray diffraction in accordance with the same procedure as in Example 1, and the results show that the full width of half maximum was about 0.35 degree (°) at (111) plane. Using the obtained Si nanoparticles, a negative active material was fabricated in accordance with the same procedure as in Example 1, and a prismatic battery cell was fabricated using the same.

### EXAMPLE 5

A prismatic battery cell was fabricated in accordance with the same procedure as in Example 1, except that the negative active material was mixed with artificial graphite in a weight ratio of about 1:4 to provide a negative active material slurry.

### COMPARATIVE EXAMPLE 1

Si particles were pulverized by using zirconia beads having a particle diameter of about 250 μm for about 40 hours to provide Si nanoparticles having an average particle diameter (D50) of about 160 nm. The Si nanoparticles were analyzed for X-ray diffraction in accordance with the same procedure as in Example 1, and the results show that the full width of half maximum as about 0.30 degree (°) at (111) plane.

Using the obtained Si nanoparticles, a prismatic battery cell was fabricated in accordance with the same procedure as in Example 1.

### COMPARATIVE EXAMPLE 2

Si particles were pulverized by using zirconia beads having a particle diameter of about 500 μm for about 40 hours to provide Si nanoparticles having an average particle diameter (D50) of about 160 nm. The Si nanoparticles were analyzed for X-ray diffraction in accordance with the same procedure as in Example 1, and the results show that the full width of half maximum was about 0.28 degree (°) at (111) plane.

Using the obtained Si nano particles, a prismatic battery cell was fabricated in accordance with the same procedure as in Example 1.

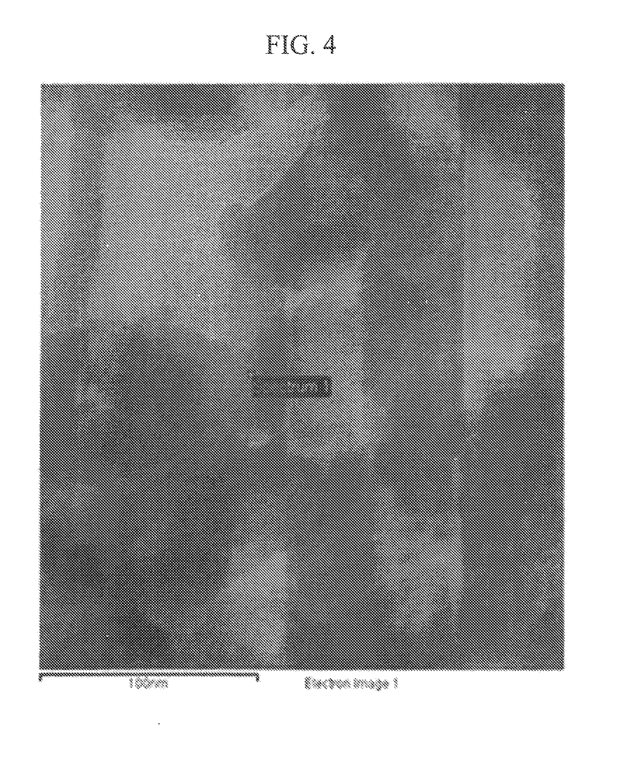

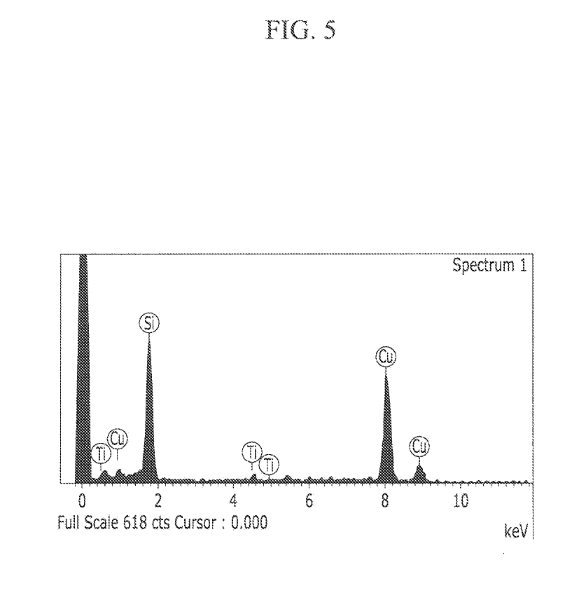

FIG. 4 shows a transmission electron microscope (TEM) photograph of a Si nano particle coated with TiO₂₋ₓ (0≦x≦1) obtained from Example 1. FIG. 5 shows EDX analysis results in the spectrum 1 of FIG. 4. As shown in FIG. 4 and FIG. 5, it is confirmed that the Si nano particle according to Example 1 was coated with TiO₂₋ₓ (0≦x≦1).

Each prismatic battery cell obtained from Examples 1 to 4 and Comparative Examples 1 and 2 was charged in 1 C and discharge in 1 C with the charge end voltage of about 4.35V and the discharge end voltage of about 2.5V to perform the charge and discharge test. The results are shown in the following Table 1.

TABLE 1

| | Full width at half | | Cycle-life |
|---|---|---|---|
| | maximum (FWHM) | Si D50 particle | (100^{th} capacity/ |
| | at (111) plane (degree) | size (PSA) | 1^{st} capacity) |
| Example 1 | 0.50 | 120 nm | 96% |
| Example 2 | 0.45 | 140 nm | 95% |
| Example 3 | 0.40 | 160 nm | 92% |
| Example 4 | 0.35 | 180 nm | 89% |
| Comparative | 0.30 | 160 nm | 75% |
| Example 1 | | | |
| Comparative | 0.28 | 160 nm | 76% |
| Example 2 | | | |

As shown in Table 1, the battery cells including the negative active materials of Examples 1 to 4 had superior cycle-life characteristics to those according to Comparative Examples 1 and 2.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A negative active material for a rechargeable lithium battery, the negative active material comprising a carbon-nanoparticle composite comprising:
a crystalline carbon material including pores; and
amorphous nanoparticles dispersed either inside the pores of the crystalline carbon material, or on the surface of the crystalline carbon material, or both inside the pores and on the surface of the crystalline carbon material,
at least one of said amorphous nanoparticles includes a metal oxide layer in a form of a film on the surface of the amorphous nanoparticle, and
said amorphous nanoparticles have a full width at half maximum of about 0.35 degree (°) or greater at a crystal plane producing the highest peak as measured by X-ray diffraction analysis.

2. The negative active material for a rechargeable lithium battery of claim 1, wherein the crystalline carbon material comprises natural graphite, artificial graphite, or a mixture thereof.

3. The negative active material for a rechargeable lithium battery of claim 1, wherein the crystalline carbon material has a porosity of about 15% to about 50%.

4. The negative active material for a rechargeable lithium battery of claim 1, wherein the amorphous nanoparticles comprises a material selected from the group consisting of:
silicon (Si);
a silicon-containing alloy (Si—X), wherein X is not Si and is an element selected from a group consisting of an alkali metal, an alkaline-earth metal, a group 13 element, a group 14 element, a group 15 element, a group 16 element, a transition element, a rare earth element, and a combination thereof;
tin (Sn);
a tin-containing alloy (Sn—X′), wherein X′ is not Sn and is an element selected from a group consisting of an alkali metal, an alkaline-earth metal, a group 13 element, a group 14 element, a group 15 element, a group 16 element, a transition element, a rare earth element, and a combination thereof;
lead (Pb);
indium (In);
arsenic (As);
antimony (Sb);
silver (Ag); and
a combination thereof.

5. The negative active material for a rechargeable lithium battery of claim 1, wherein the amorphous nanoparticles comprise silicon nanoparticles having a full width at half maximum of about 0.35 degree (°) or greater at a crystal plane showing the highest peak as measured by X-ray diffraction analysis.

6. The negative active material for a rechargeable lithium battery of claim 1, wherein the amorphous nanoparticles have an average particle diameter of about 50 nm to about 200 nm.

7. The negative active material for a rechargeable lithium battery of claim 1, wherein the metal oxide layer is formed at a thickness of about 1 nm to about 20 nm.

8. The negative active material for a rechargeable lithium battery of claim 1, wherein the metal oxide layer comprises an oxide of metal selected from the group consisting of titanium (Ti), copper (Cu), iron (Fe), molybdenum (Mo), aluminum (Al), and a combination thereof.

9. The negative active material for a rechargeable lithium battery of claim 1, wherein the metal oxide of metal oxide layer is included in about 1 to about 5 parts by weight based on 100 parts by weight of the amorphous nanoparticles.

10. The negative active material for a rechargeable lithium battery of claim 1, wherein the amorphous nanoparticles are included in about 5 to about 25 parts by weight based on 100 parts by weight of the crystalline carbon material.

11. The negative active material for a rechargeable lithium battery of claim 1, wherein the negative active material further comprises an amorphous carbon surrounding the crystalline carbon material.

12. The negative active material for a rechargeable lithium battery of claim 11, wherein the amorphous carbon is present in at least one pore of carbon nanoparticle composite.

13. The negative active material for a rechargeable lithium battery of claim 11, wherein the amorphous carbon is present between the surface of crystalline carbon material and the amorphous nanoparticles.

14. The negative active material for a rechargeable lithium battery of claim 11, wherein the amorphous carbon comprises a material selected from a group consisting of soft carbon (low temperature baked carbon), hard carbon, mesophase pitch carbide, baked coke, and a mixture thereof.

15. The negative active material for a rechargeable lithium battery of claim 1, wherein the amorphous carbon is included in about 5 to about 25 parts by weight based on 100 parts by weight of the crystalline carbon material.

16. The negative active material for a rechargeable lithium battery of claim 1, wherein the crystalline carbon material has a particle diameter of about 1 micrometer to about 15 micrometer.

17. The negative active material for a rechargeable lithium battery of claim 1, wherein the negative active material has a particle diameter of about 5 to about 40 micrometer.

18. A method of manufacturing a negative active material for a rechargeable lithium battery, comprising
milling particles by using beads having an average particle diameter of about 50 μm to about 300 μm for about 24 hours or longer to provide amorphous nanoparticles;
mixing the amorphous nanoparticles with a composition comprising a metal oxide precursor and heating the mixture to form a metal oxide layer on the surface of the amorphous nanoparticles; and
mixing and combining the amorphous nanoparticles formed with the metal oxide layer on the surface thereof with a crystalline carbon material including pores.

19. The method of claim 18, wherein the process of heating the mixture of the amorphous nanoparticles and the solution comprising the metal oxide precursor is performed at about 400° C. to about 600° C.

20. A method of manufacturing a negative active material, comprising:
milling particles by using beads having an average particle diameter of about 50 μm to about 300 μm for about 24 hours or longer to provide amorphous nanoparticles;
mixing the amorphous nanoparticles with a composition comprising a metal oxide precursor to provide amorphous nanoparticles formed with a metal oxide layer on the surface thereof;
mixing the amorphous nanoparticles formed with the metal oxide layer on the surface thereof with a crystalline carbon material including pores and heating the mixture to combine the amorphous nanoparticles formed with the metal oxide layer on the surface thereof and the crystalline carbon material including pores.

21. The method of claim 20, wherein the heating process after mixing the amorphous nanoparticles formed with the metal oxide on the surface thereof with the crystalline carbon material including pores is performed at about 400° C. to about 600° C.

22. A rechargeable lithium battery, comprising
a negative electrode comprising a negative active material of claim 1;
a positive electrode comprising a positive active material; and
a non-aqueous electrolyte.

23. The rechargeable lithium battery of claim 22, wherein the negative electrode comprises a mixture of the negative active material and another crystalline carbon material.
